(19) United States
(12) Patent Application Publication
(10) Pub. No.: US 2008/0017267 A1
(43) Pub. Date: Jan. 24, 2008

(54) Moulded Body with Evaporation-Sputtered Layers

(75) Inventors: Marc Van Hooren, Bernbach (DE); Tevfik Severengiz, Gelnhausen (DE); Volker Naumann, Bad Orb (DE)

Correspondence Address: BUCHANAN, INGERSOLL & ROONEY PC, POST OFFICE BOX 1404, ALEXANDRIA, VA, 22313-1404, US

(73) Assignees: Veritas AG, Gelnhausen (DE); Applied Films GMBH & Co. KG, Alzenau (DE)

(21) Appl. No.: 11/597,278

(22) PCT Filed: May 27, 2005
(86) PCT No.: PCT/EP05/05725

§ 371 Date: Apr. 11, 2007

(30) Foreign Application Priority Data
May 27, 2004 (DE) 1 2004 025 919.4

(51) Int. Cl. F16L 11/12

(52) U.S. Cl. 138/139; 138/143

(57) ABSTRACT

The invention relates to moulded bodies which comprise evaporation-sputtered layers, and pipes or tubes which comprise these types of layers for increasing the barrier properties.

The invention relates to moulded bodies which comprise evaporation-sputtered layers, and pipes or tubes which comprise these types of layers for increasing the barrier properties.

### BACKGROUND OF THE INVENTION

Various types of moulded bodies, such as for example tubes and pipes, are known for use with regard to the transport of liquid or gaseous media. Normal fields of use for this type of moulded body are for example fuel pipe systems on a motor vehicle or industrial pipe systems which transport basic substances or process gases, such as alcohols, superheated steam, etc. Normally in these fields of use a moulded body is used in the shape of a tube or pipe which comprises a plastic layer as the basic body, for example formed from normal plastics, such as polyolefins, polyamides or similar substances. This layer, which is termed the basic body layer in this application, determines the essential shape of a moulded body as well as some essential properties.

However, these types of basic body layers frequently exhibit only an inadequate barrier property with respect to the substances to be transported, so that there is a risk that polluting substances may escape through the pipe or tube walls, so that the risk of the loss of substance to be transported is high, which can cause environmental pollution or impair the workplace safety or the functioning of complex systems which comprise this type of pipe or tube. Alternatively, in some cases, however, it is also desirable that permeation from outside into a pipe or tube is prevented. This is particularly desirable with pipes or tubes which are laid underground and are used for the supply of drinking water. With systems of this type it must be ensured that, where applicable, polluting substances present in the ground do not enter the drinking water which is being transported in the pipe.

Since, as outlined above, the plastics normally used do not show any adequate barrier effect against the penetration of substances, separate barrier layers are widely used in the state of the art. Examples of these types of barrier materials, which can be provided on the outside or inside of the pipes or tubes, are special plastics, such as fluorine-containing polymers or inorganic substances, such as metal films or ceramic films.

Very popular in this connection is the use of metal foils which are wound around plastic pipes or plastic tubes. Thus for example, the applications US 2003/0,049,400 A1, US 2003/0,049,401 A1 and EP 1 113 208 A2 disclose plastic tubes on which a barrier layer of a metal foil has been wound. In this connection an aluminum foil is often used which is wound around a base pipe using a suitable method. In this way a very good barrier property can be obtained. A disadvantage with this technique however is that comparatively thick metal layers (for example up to 200 μm) are used which implies a relatively high consumption of material. As a result, the flexibility and elasticity of the pipe are impaired. At the same time with these types of pipes leakage problems often occur, because the winding of the base pipe with metal foil does not facilitate complete sealing. Therefore, with these types of systems often adhesive layers and further sealing layers are used, rendering the manufacturing method for these types of pipes complicated and expensive.

Other methods which are known in the state of the art for applying thin layers onto hollow bodies, include plasma coating methods in which films of polymer materials or carbon are deposited onto the inner or outer surfaces of hollow bodies. Thus EP 0 708 185 B1 discloses a device for treating surfaces, in particular the inner surfaces of fuel tanks. This device facilitates the application of an internal coating by plasma methods. EP 0 739 655 B1 discloses methods for the plasma aided manufacture of multifunctional layers on plastic parts. This publication discloses in particular the deposition of thin layers of different monomer constituents to vary the properties of the deposited layers. DE 3 932 748 C2 discloses a method of coating hollow bodies in which the hollow body to be coated is put into a microwave chamber, after which plasma-polymerisable monomers are then introduced, giving a polymer covering layer after suitable excitation. Finally, WO 98/37265 discloses a method and a device for manufacturing plastic containers with a carbon-film coating.

In the state of the art other techniques of applying metal films on moulded bodies have also been examined. Thus, EP 1 020 673 A1 discloses a plastic pipe for the transport of a carbon dioxide coolant. This pipe is characterised by a large number of layers, whereby at least one metal layer is provided which is impermeable to carbon dioxide, whereby this layer is located between two plastic layers. The metal layer is produced by a vapour deposition method and consists, for example, of aluminum. Also, the international publication WO 02/01115 A1 discloses a plastic pipe which is provided with a barrier layer. This barrier layer is located on the outside of the plastic pipe and is produced by a physical vapour deposition method in a high vacuum. The thickness of this barrier layer, which can comprise for example aluminum, an aluminum alloy or aluminum oxide, is preferably less than 1 μm.

The international publication WO 02/16485 A2 discloses a hollow body structure, which comprises a barrier layer on the outside of a basic body layer. This barrier layer can in turn be produced by vapour deposition methods and comprises for example silicon, aluminum, nickel, chrome or copper. Alternatively, an oxidic barrier layer can also be provided, for example of silicon oxides. The international publication mentioned above discloses that preferably combined barrier layers are implemented which comprise both a metallic layer as well as an oxide layer. The average thickness of these combined barrier layers is 50 nm.

DE 69704076 T2 describes wound or folded protective sleeves which enclose cables, wires or pipes to protect them. In this way, the cables or pipes are to be protected from the effects of heat. Due to the application of the wound or folded protective sleeves described in this application, openings or slots occur, in particular because the protective sleeves should be able to be installed subsequently over an already laid pipe or cable.

DE 4328016 A2 describes the delaminatable composite materials for packaging in the foodstuffs industry, which can be broken down sorted after use into their constituent parts. In order to ensure this, a separation layer of a soluble polymeride is provided in each case between two films.

DE 4122119 A1 discloses a multilayer oxygen barrier film which is wound around a plastic pipe. Also here, there are again openings and gaps as already described above in connection with DE 69704076 T2.

Overall though with regard to the state of the art it can be said that the optimum combination of a thin, but secure barrier layer, which at the same time can be easily processed, giving good properties in the end product has not yet been achieved, in particular when the barrier layer is to be provided on the inside of a moulded body. The state of the art essentially discloses that the barrier layer is applied as an outer layer on a basic body layer, whereby the basic body layer in this connection is represented by a moulded body with adequate dimensional stability which essentially determines the shapes and properties of the final moulded body (refer to the above definition of this term).

### OBJECT OF THE INVENTION

Based on the disadvantages in the state of the art outlined above, the object of the invention is to provide an improved barrier structure for moulded bodies, in particular pipes or tubes, whereby this barrier structure develops a secure barrier effect, but is at the same time configured very thin so that no excessive material consumption is necessary. Furthermore, the barrier structure should also be able to be applied to the inside of moulded bodies, such as tubes or pipes.

### BRIEF DESCRIPTION OF THE INVENTION

The object outlined above is solved by the moulded body according to claim 1. Preferred developments arise in the dependent claims. Furthermore, the invention also provides a barrier structure as it is defined in claim 10. Preferred developments again arise in the corresponding dependent claims. Furthermore, the invention makes available a method for increasing the barrier properties of moulded bodies as well as the use of the above described barrier structure for increasing the barrier effect of moulded bodies.

### DETAILED DESCRIPTION OF THE INVENTION

According to the invention, through the use of methods known in principle, which are suitable for applying thin metallic or oxidic (dielectric) layers, a thin barrier layer of a metallic or oxidic material can also be formed on the inside of a moulded body. The methods of application to be considered within the scope of the invention comprise vapour deposition (such as PVD), chemical deposition methods and sputtering. In this connection sputtering is preferred.

The materials to be deposited as the barrier layer can be selected from the normal materials, whereby the popular materials, such as aluminum, silicon, nickel, chrome and copper can be used as metallic elements. Aluminum is preferred in this connection. Silicon oxides and aluminum oxides can be used as oxidic materials.

The thickness of the barrier layer to be applied according to the invention is normally about 10 to 100 nm, preferably 30 to 50 nm, in particular preferably about 40 nm.

As outlined above, this layer is preferably produced by sputtering, because in this way a very dense and compact layer can be obtained. As a result, an excellent barrier effect can be ensured with simultaneous minimal impairment of the deformation properties of the pipe or tube.

These types of barrier layers can also be produced on the inside of moulded bodies by using suitable devices which are in principle known to the person skilled in the art.

In this connection it is preferable that the above described barrier layer is enclosed by two plastic layers so that in total a three-layered barrier structure is created. The total thickness of this three-layered barrier structure is preferably less than 2 μm, whereby the two plastic layers enclosing the barrier layer are formed approximately equally thick. The respective thicknesses are given by the details provided above with regard to the overall thickness and the thickness of the barrier layer. Thus it is preferred when the two plastic layers enclosing the barrier layer are about 1 μm thick.

Preferred developments of this three-layered barrier structure comprise a first plastic layer, for example in one of the following described plastics, a barrier layer in a metallic or oxidic substance, and a second plastic layer, whereby the plastic, which can be different from the plastic of the first layer, is in turn selected from the following listed materials.

The barrier structure described above is suitable for increasing the barrier effect of moulded bodies, in particular pipes and tubes.

In this respect the two plastic layers enclosing the barrier layer provide protection of the barrier layer as well as an improvement in the adhesion to a basic body layer, for example a plastic pipe or plastic tube. The person skilled in the art can in this connection select suitable materials for the two plastic layers so that a desired combination of properties (good protective effect for the barrier layer and good adhesive properties with respect to the basic body layer) is achieved.

In this connection preferably the three-layered barrier structure is constructed as follows:

The first layer is a polymer layer applied in a vacuum, which can be cross-linked by radiation and which preferably is based on acrylate materials or cationic polymerisable materials. Then the metallic or dielectric (oxidic) layer is provided, preferably applied by sputtering, on which then in turn a polymer layer, which can be cross-linked by radiation, is applied in a vacuum, the said polymer layer corresponding to the polymer layer which can be cross-linked by radiation and is described above.

This three-layered barrier layer can be easily provided on the outside of plastic hollow bodies, in particular pipes. As already described above, the middle metallic or oxidic layer provides the increase in the barrier properties, whereas the two polymer layers provide protection of the barrier layer and also give an improvement in the adhesion of the barrier layer to the basic body layer.

Further functional layers can then be provided beyond this three-layered barrier structure applied outside on the hollow body, as already known in principle in the state of the art.

Alternatively, it is also possible though to provide this three-layered barrier structure on the inside of a hollow body. To achieve this, for example the three-layered barrier structure can be formed by the methods known in principle on a suitable moulding surface. After producing the three-layered barrier structure, a further coating can occur through conventional methods so that after the separation of the moulding surface, a hollow body is obtained which comprises the three-layered barrier layer on the inside.

The methods to be employed in connection with this particularly preferred embodiment, in particular for applying the metallic or oxidic layer by sputtering, as well as for applying the polymer layers in the vacuum are known in principle to the person skilled in the art. In this connection reference can be made to the publications quoted in the introductory part of this application where they relate to plasma polymerisation methods. Furthermore, in this connection reference can be made to the PML coating technique already known in the state of the art (PML: Polymer Multi-Layer).

In particular the preferred embodiments of the invention facilitate the application of a barrier layer without openings and gaps, because preferably the barrier layer is applied directly to the moulded body, in particular to the pipe or tube, without the folding or winding methods being used. In line with the preferred embodiments of the invention, the barrier layer is directly applied, in particular in the three-layered embodiment, to a hollow body so that an extraordinarily good barrier effect is obtained. In addition, in particular for the preferred embodiment of the three-layered development, extraordinary adhesion and sealing of the barrier is ensured by the use of monomers or plastics which can be cross-linked by radiation. In this connection plastic layers of acrylates or cationic polymerised plastics are preferred which are normally applied in a vacuum in the monomer form and then cross-linked by radiation. This cross-linking by radiation for the production of a three-dimensionally cross-linked plastic ensures particularly good properties of the preferred embodiment of the invention. In this connection acrylate monomers are preferred with a molecular weight of up to 3,000, which are then cured and cross-linked by a PML technique. In this connection reference is made to the US patents U.S. Pat. No. 5,725,909, U.S. Pat. No. 5,811,183, U.S. Pat. No. 5,877,895, U.S. Pat. No. 6,218,004 and U.S. Pat. No. 6,231,939, which are included here through reference, with regard to their disclosure of the PML method as well as the monomers and process parameters used in this connection. The plastic layer obtained through this type of method is extremely resilient and durable, also and particularly with regard to long-term use in environments in which the moulded bodies of the invention are exposed to environmental influences, such as mechanical stress, humidity, different pH values, etc.

As outlined above, the preferred plastic layers of the preferred embodiments of the invention comprise materials produced from acrylates or cationic polymerised plastics. These types of plastic layers are obtained through vapour deposition methods in a vacuum (vapour deposition of monomers) and then cross-linking by radiation, so that very thin but also at the same time very durable plastic layers are produced. These types of layers can also be directly applied to the moulded bodies according to the invention so that subsequent application methods, such as adhesive, winding or holding methods are not required.

Examinations of the barrier properties of pipes and tubes according to the invention have shown that with the barrier layers according to the invention, which are formed very thinly, an excellent barrier property can be obtained. Compared to classical layer structures, for example with fluorine-containing barrier layers, a multiple improvement in the barrier properties can be obtained. Thus, with pipes in Polyamide 12 an up to eight times improvement in barrier properties could be obtained compared to classical layer structures using metallic coatings, in particular aluminum. The use of oxidic barrier layers, in particular silicon oxide, gave an improvement of up to 16 times for these barrier properties.

Thus, through this invention the barrier property of plastic pipes can be extremely improved. At the same time the barrier layers can be formed extremely thinly so that no excessive material consumption occurs. Due to the sandwiching of the metallic or oxidic barrier layer in the two plastic layers described above, a good protection of the very thin barrier layer can be obtained at the same time. In addition, the adhesion to the basic body layer is ensured.

Thus, overall substantial potential savings with regard to classical barrier layers can be realised, whereby at the same time it is always ensured that a barrier layer can be provided outside around the basic body as well as on the inside.

Suitable developments of the moulded body according to the invention are, in particular, pipes and tubes which can be built up in one or multiple layers. In this connection the known materials for constructing pipes and tubes can be employed, whereby after selecting a suitable material for the basic body layer, the person skilled in the art can make a suitable choice for the plastic layers preferred according to the invention for the barrier structure.

In particular, in this connection it is preferable that the material for the basic body layer of the moulded body according to the invention is selected from polyolefins, polyamides or elastomers or rubber materials, whereby single layer or multilayer structures can be present. Suitable materials are in particular polyamides, such as Polyamide 6, Polyamide 6.6 or Polyamide 12, elastomers, such as NBR, HNBR or ECO and polyolefin materials, such as polyethylene or polypropylene.

Simple moulded bodies according to the invention comprise for example a basic body layer of NBR, additionally provided with a barrier layer or three-layered barrier structure according to the invention, located inside or outside. This simple basic structure is also possible with basic body layers in polyamide or polyolefins.

The basic body layer in one of the materials listed above thus additionally comprises the barrier layer or three-layered barrier structure according to the invention, whereby the barrier layer is preferably provided on the inside. The barrier layer is preferably formed as a three-layered barrier structure which can be provided inside as well as outside.

The materials for the two outer plastic layers of the three-layered barrier structure can be selected from the materials listed above. Alternatively, other material developments are conceivable. Thus, in particular the plastic layer of the three-layered barrier structure located inside the final pipe or tube can also be selected from fluoro-thermoplastic materials, preferably THV, ECTFE, CTFE and ETFE. A layer of this type represents an additional barrier protection for the barrier layer of the invention. The other plastic layer of the three-layered barrier structure is then made of materials which ensure good adhesion to the material of the basic body layer. This development is in particular practicable for barrier layers located inside. With barrier layers located outside the material choice is appropriately adapted. Here in particular, the outside layer of the three-layered barrier structure should develop a good protective effect against mechanical stress, whereby known materials for protective layers are preferred, in particular elastomers and materials such as CM, ECO, ACM, CSM, AEM, CR or EVM. With this type of development of the moulded part according to the invention, the plastic layer, located inside, of the three-layered barrier structure is then in turn selected with regard to good adhesion properties with the material of the basic body layer.

As already outlined above, the basic body layer can be realised with one or multiple layers. Apart from the principal basic body layer, suitable multilayered structures comprise further functional layers, such as protective layers, conventional barrier layers, coloured marking layers, reinforcement layers, such as layers containing fibres, etc. The suitable layer structures, layer materials and respective layer thicknesses are known in principle to the person skilled in the art.

The pipes and tubes according to the invention can be continuously produced using suitable equipment. Especially suitable in this connection is a combined production line with a station for producing the barrier layer and a station for producing the basic body layer and further optional stations for the application of additional layers.

1-16. (canceled)

17. Moulded body, in particular a pipe or tube, comprising a basic body layer and a barrier layer, wherein the barrier layer has been obtained by a sputtering or vapour deposition method, wherein the barrier layer is a three-layered barrier structure of a thickness of less than 2 μm, comprising a barrier layer and two plastic layers enclosing it, wherein the barrier layer comprises a metallic layer and/or an oxidic layer, applied by sputtering, wherein the two plastic layers are applied in a vacuum and are polymer layers cross-linked by radiation.

18. Moulded body according to claim 17, wherein the barrier layer is located inside.

19. Moulded body according to claim 17, wherein the barrier layer exhibits a thickness of 10 to 100 nm.

20. Moulded body according to claim 17, wherein the barrier layer is formed as a three-layered barrier structure, with a barrier layer located inside and two enclosing plastic layers.

21. Moulded body according to claim 17, wherein the material for the basic body layer is selected from polyamides and elastomer materials.

22. Moulded body according to claim 21, wherein the elastomer material comprises NBR.

23. Moulded body according to claim 17, wherein the material for the basic body layer is selected from polyamides and elastomer materials, wherein the barrier layer is located inside and wherein the barrier layer comprises aluminum, aluminum oxide, silicon or silicon oxide.

24. Three-layered barrier structure, comprising a barrier layer located inside and two plastic layers enclosing the barrier layer, wherein the thickness of the three-layered barrier structure is at the most 2 μm, wherein the barrier layer comprises a metallic layer and/or an oxidic layer, applied by sputtering, wherein the two plastic layers are applied in a vacuum and are polymer layers cross-linked by radiation.

25. Barrier structure according to claim 24, wherein the thickness of the barrier layer is 10 to 100 nm, preferably 30 to 50 nm.

26. Barrier structure according to claim 24, wherein the material for the barrier layer is selected from aluminum, silicon, chrome, nickel and copper as well as aluminum oxide or silicon oxide.

27. Use of a three-layered barrier structure according to claim 25 on the inside or outside of a plastic pipe for improving the barrier properties of the plastic pipe.

28. Use according to claim 27, wherein the plastic pipe is formed from a polyamide or an elastomer material.

29. Method of increasing the barrier property of a moulded body, preferably a hollow body (pipe, tube), comprising the application of at least one barrier structure onto a basic body layer, wherein the barrier structure is a barrier structure according to claim 24.

30. Moulded body according to claim 18, wherein the barrier layer exhibits a thickness of 10 to 100 nm.

31. Moulded body according to claim 30, wherein the barrier layer is formed as a three-layered barrier structure, with a barrier layer located inside and two enclosing plastic layers.

32. Moulded body according to claim 31, wherein the material for the basic body layer is selected from polyamides and elastomer materials.

33. Moulded body according to claim 32, wherein the material for the basic body layer is selected from polyamides and elastomer materials, wherein the barrier layer is located inside and wherein the barrier layer comprises aluminum, aluminum oxide, silicon or silicon oxide.

34. Barrier structure according to claim 25, wherein the material for the barrier layer is selected from aluminum, silicon, chrome, nickel and copper as well as aluminum oxide or silicon oxide.

35. Method of increasing the barrier property of a moulded body, preferably a hollow body (pipe, tube), comprising the application of at least one barrier structure onto a basic body layer, wherein the barrier structure is a barrier structure according to claim 34.

36. Method for modifying properties of a plastic pipe barrier structure with a three-layered barrier structure on the inside or outside of the plastic pipe, wherein the thickness of the barrier layer is 10 to 100 nm, comprising:
forming a three-layered barrier structure with a barrier layer located inside and two plastic layers enclosing the barrier layer, wherein the thickness of the three-layered barrier structure is at most 2 μm; and
sputtering a metallic layer and/or an oxidic layer on the barrier layer, wherein the two plastic layers are applied in a vacuum and are polymer layers cross-linked by radiation.
